(19) United States
(12) Patent Application Publication
(10) Pub. No.: US 2017/0286626 A1
(43) Pub. Date: Oct. 5, 2017

(54) MULTI-DIMENSIONAL TIMELINE SYSTEM FOR INTEGRATED TREATMENT VIEWING, PLANNING AND COORDINATION

(71) Applicant: Varian Medical Systems, Inc., Palo Alto, CA (US)

(72) Inventors: Anoop JAYAKUMAR, The Colony, TX (US); Brian SPATOLA, Huntington Beach, CA (US); Daniel ROSENBERG, San Jose, CA (US)

(21) Appl. No.: 15/087,664

(22) Filed: Mar. 31, 2016

(51) Int. Cl. G06F 19/00

(52) U.S. Cl. CPC G06F 19/3437; G06F 19/322; G06F 19/3431; G06F 19/3487

(57) ABSTRACT

A system and method of generating a clinical timeline user interface includes receiving a plurality of clinical information items associated with at least one relationship between a healthcare provider entity and a patient entity, each clinical information item having an associated time. The method also includes filtering the clinical information items according to a relationship, the relationship comprising an indicated healthcare provider entity and at least one indicated patient. The method further includes ordering the filtered clinical information items according to the associated time and generating a clinical timeline according to the ordered clinical information items.

### TECHNICAL FIELD

This description relates generally to the field of healthcare user interface systems, and more particularly to a timeline user interface system for information viewing, planning and coordination.

### BACKGROUND

Healthcare environments involve multiple professionals partaking in various tasks treating and managing multiple patients. Patient information and clinical information exist in a number of sources that include disparate information systems from a variety of vendors and a variety of healthcare providers. Such information also exists in a number of dimensions of healthcare relationships that include one doctor to one or more patients under the care, one nurse to one or more patients under the care, a care team to one or more patients under care, etc.

Conventionally, when a clinician logs into the user interface of a healthcare management system, the clinician may only be able to view or access historical events and data from the perspective of the account of the clinician himself or herself. Viewing the historical data, the clinician is often unaware of what other doctors, nurses, teams have treated, ordered or scheduled for a particular patient, let alone what other clinicians may have already decided for a particular patient in the future. Therefore, key decisions are made with limited knowledge available to the clinician due to the ineffective and limited promulgation and presentation of the clinical data.

For example, in the case of a patient scheduled for radiation therapy, an existing system may be aware of a number of necessary appointments and treatment orders, but they may not be necessarily compatible with treatment plans that particular physician thinks are optimal and would like to advise. Absent a streamlined tool providing ease and multi-dimensional access, manual coordination of appointments with treatment plans and treatment results requires a significant amount of time for gathering, collating and analyzing information. The consequences of a mistake in this area can be severe for the patient and also add unnecessary cost to the overall course of treatment.

Therefore, there exists a need for a user interface that provides a running timeline presentation of clinical events and data encompassing periods in past, present and future.

### SUMMARY

According to an embodiment of the present disclosure, a method of generating a clinical timeline user interface system includes receiving a plurality of clinical information items associated with at least one relationship between a healthcare provider entity and a patient entity, each clinical information item having an associated time past or present. The method also includes filtering the clinical information items according to a relationship, the relationship comprising an indicated healthcare provider entity and at least one indicated patient. The method further includes ordering the filtered clinical information items according to the associated time and generating a clinical timeline according to the ordered clinical information items.

According to another embodiment of the present invention, a clinical timeline user interface system includes a memory that stores machine-readable instructions and a processor communicatively coupled to the memory. The processor is operable to execute the instructions to generate a clinical timeline user interface, where the process includes receiving a plurality of clinical information items from a plurality of disparate sources each associated with at least one relationship between a healthcare provider entity and a patient entity, each clinical information item having an associated time. The process also includes filtering the clinical information items according to a relationship, the relationship comprising an indicated healthcare provider entity and at least one indicated patient. The process further includes ordering the filtered clinical information items according to the associated time and generating a clinical timeline according to the ordered clinical information items.

According to yet another embodiment of the present invention, a non-transitory computer readable storage medium having embedded therein program instructions, when executed by one or more processors of a device, causes the device to execute a process for generating a clinical timeline. The process includes receiving a plurality of clinical information items from a plurality of disparate sources each associated with at least one relationship between a healthcare provider entity and a patient entity, each clinical information item having an associated time. The process also includes filtering the clinical information items according to a relationship, the relationship comprising an indicated healthcare provider entity and at least one indicated patient. The process further includes ordering the filtered clinical information items according to the associated time and generating a clinical timeline according to the ordered clinical information items.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 illustrates an exemplary computer environment for generating and presenting a clinical timeline user interface in accordance with an embodiment of the present invention;

FIG. 2A illustrates an exemplary on-screen graphical user interface (GUI) including a one-to-one clinical timeline in accordance with an embodiment of the present invention;

FIG. 2B illustrates another exemplary on-screen graphical user interface (GUI) including a many-to-one clinical timeline in accordance with an embodiment of the present invention;

FIG. 3A illustrates the exemplary clinical timeline of FIG. 2A displaying data of a one-to-many healthcare relationship in accordance with an embodiment of the present invention;

FIG. 3B illustrates the exemplary clinical timeline of FIG. 2A displaying data of a many-to-one healthcare relationship in accordance with an embodiment of the present invention;

FIG. 3C illustrates the exemplary clinical timeline of FIG. 2A displaying data of a one-to-many healthcare relationship in accordance with an embodiment of the present invention;

FIG. 4 illustrates another exemplary clinical timeline of FIG. 2B displaying data of a many-to-one healthcare relationship in accordance with an embodiment of the present invention; and

FIG. 5 is a flow chart of an exemplary computer implemented method of generating a clinical timeline in accordance with an embodiment of the present invention.

### DETAILED DESCRIPTION

A graphics display as described herein may encompass alternative embodiments of a software program or system in which functions of the system are performed by modules different to those shown herein. The graphics display can process items of data in a serial or parallel fashion, or in combination of the two, without departing from the spirit or scope of the invention.

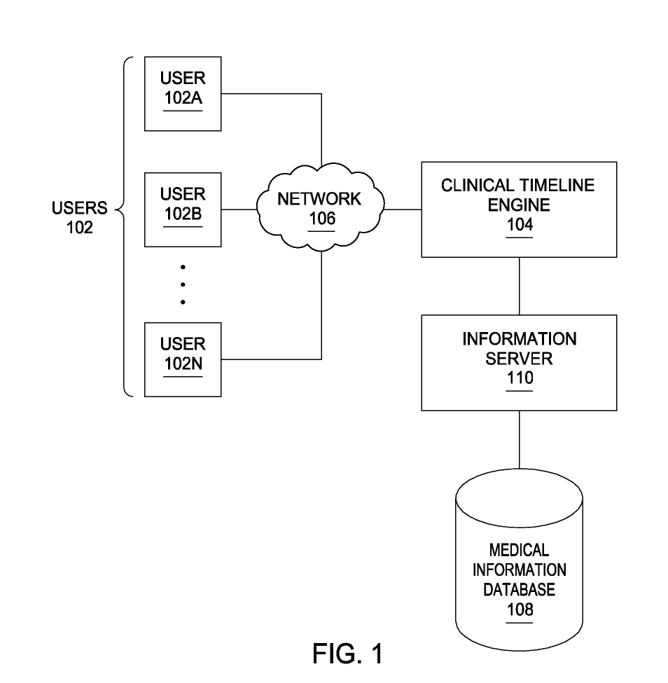

Referring to FIG. 1, an illustration of an exemplary computer environment for generating and presenting a multi-dimensional clinical timeline user interface is shown. One or more users 102, such as a user 102A, a user 102B, and a user 102N, are in communication with a clinical timeline engine 104 via communication network 106. The clinical timeline engine 104 is in communication with one or more medical information databases through one or more information servers 110. The clinical timeline engine 104 can include a clinical timeline website or any other device or application capable of providing access to and interaction with the clinical information items stored in the medical information databases 108.

The users 102 can use a computing device, such as a laptop or desktop computer, a cellular phone, a personal digital assistant, a smart phone, and so forth to access the clinical timeline engine 104. The users 102 can view a clinical timeline, review additional details of a data item presented in the clinical timeline, enter future clinical tasks to the clinical timeline, enter notes or annotation regarding a clinical event or data to the clinical timeline, and act on previously configured actions (approve treatment plans, confirm updates to patient profiles, respond to patient reported diary entries, respond to patients' messages, etc.) associated with a data item of the clinical timeline. Notes entered in the clinical timeline can but do not have to be associated with the official patient clinical record of treatment. The users 102 are typically healthcare provider entities or participants in a clinical environment, accessing the medical information databases through the clinical timeline engine 104. For example, the users 102 can be, but not limited to, doctors in charge, doctors assisting, nurse practitioners, supervising nurses, nurses, imaging specialists, lab specialists, physical therapist, dietitians, social workers, scheduling clerks, etc.

The users 102 all have relationships with one or more patients who were, are, or will be under the care of the healthcare environment the users 102 are associated therewith. Such healthcare relationships may comprise any type of relationship that exists between a healthcare provider entity and a patient seeking treatment or under treatment. For example, the user 102A can be an oncologist in charge of treating a patient A (not shown), and the user 102B can be a head nurse supervising and coordinating the treatment of all the patients, including the patient A, under the care of the oncologist user 102A. The healthcare relationships can also comprise any type of relationship that exists between multiple healthcare provider entities and one or more patients. For example, a doctor in charge, a few assisting doctors, a head nurse, a team of nurses, an imaging specialist and a dietitian can work as a designated care team for the treatment and treatment follow-ups for one or more particular patients.

In addition to the information regarding a healthcare provider entity and a patient entity, each of the healthcare relationships may have one or more clinical information items associated therewith. Such clinical information items may comprise any type of electronic medical records (EMRs) of a particular patient. Electronic medical records include, but are not limited to, clinical data such as images, clinical notes, patient charts, orders, summaries, reports, analysis, or any other type of electronic medical documentation, including digital scans of paper reports and faxes relevant to a particular patient's condition and/or treatment. Clinical information items may also comprise information relating to the occurrences of clinical events and clinical data associated with or generated from the occurrences of clinical events. Clinical events include, but are not limited to, patient encounters and/or visits, physical exams, patient participation in clinical trials, imaging scans, lab orders, patient reported experience measurements, patient reported outcome measurements (diary entries), changes to patients' profiles, patient communications, etc. Clinical data include, but are not limited to, patient profile information, images, alert history, allergies, culture results, physical examination results, vital signs, past medical history, family medical history, surgical histories, histories of present illnesses, current and past medications, symptoms, past orders, completed orders, scheduled orders, pending orders, tasks, lab results, patient encounters and/or visits, immunizations, physician comments, nurse comments, other caretaker comments, and any other relevant clinical information.

Clinical information items are searchable for one or more aspects of information stored in association therewith. For example, clinical information items can be searched based on the healthcare provider entities, the patient entities, a time when the clinical event took place or will take place, the venue where the clinical event took place or will take place, the treatment plans administrated, abnormal patient diary entries, etc. In particular, each of the clinical information items has a time associated therewith. For example, for a clinical event such as a treatment appointment between a doctor in charge and a patient, the corresponding information item may indicate a time, a day and a calendar date regarding when the appointment actually took place or is scheduled to take place. For another example, for a clinical data such as CBC (Complete Blood Count) ordered for a patient, the corresponding information item can include the timing information as when the lab test was ordered and/or when the lab test was complete and is available for access.

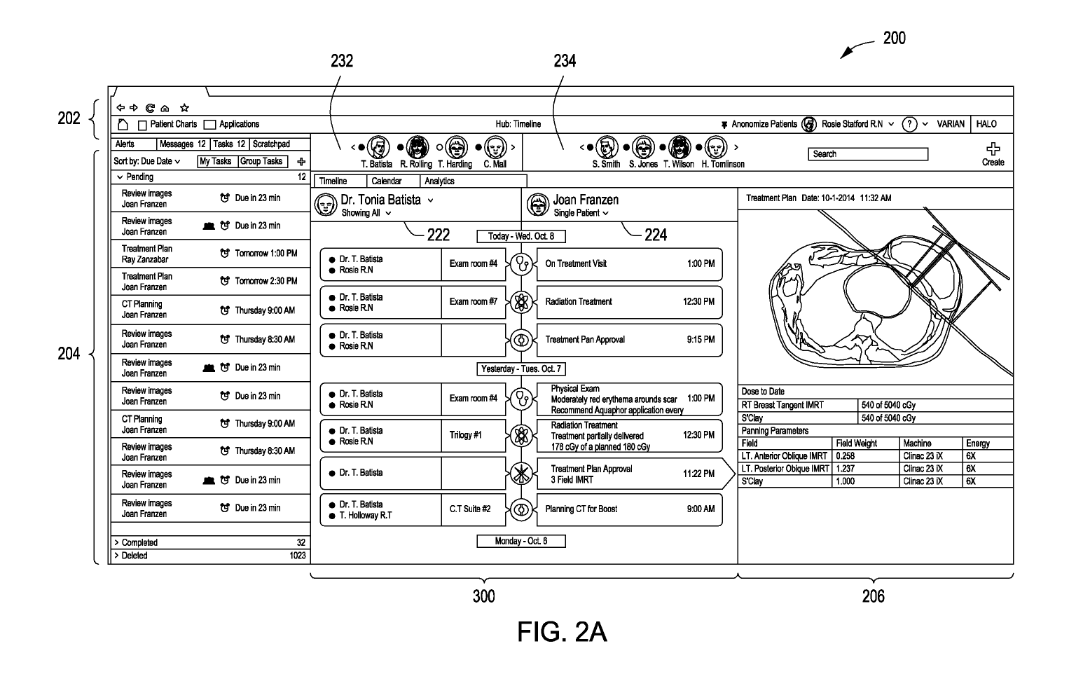

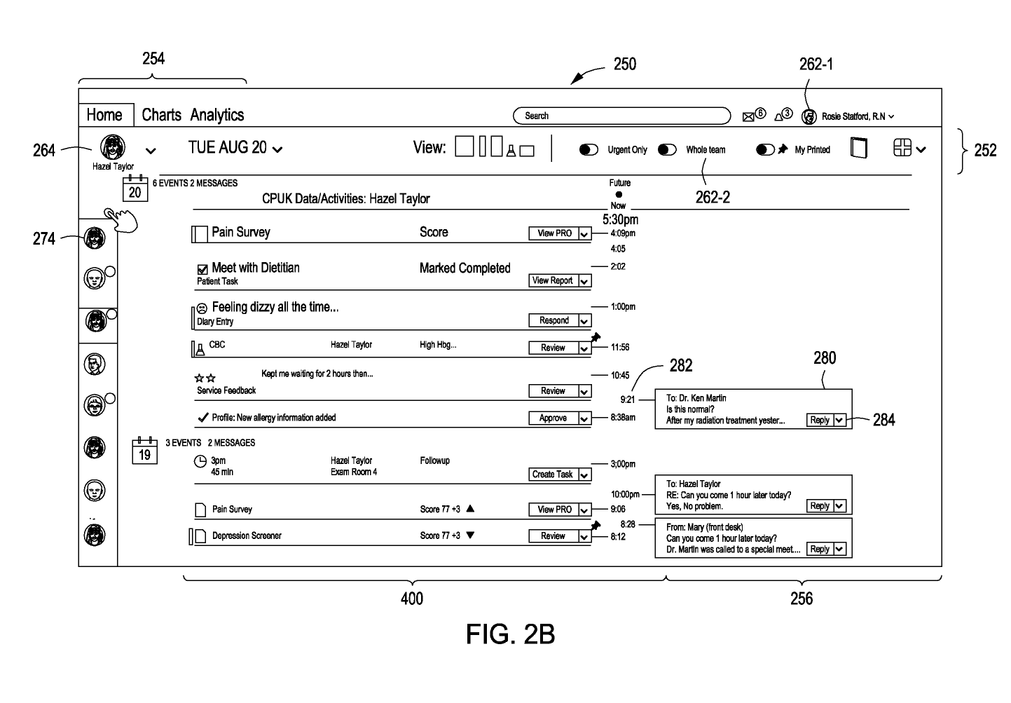

FIG. 2A illustrates an exemplary on-screen healthcare GUI 200 for managing patient care and treatment including a clinical timeline 300 for treatment viewing, planning and coordination. The GUI 200 represents a console of a medical care management system displayed to a clinician upon that particular clinician user's login account (e.g., Rosie, R.N.). The GUI 200 includes a menu bar 202, a message/task panel 204, and a clinical timeline 300. The clinical timeline 300 is shown to include a detail panel 206 to the right hand side.

The menu bar 202 is located at the top of the GUI 200 and provides access to general menus used to configure, navigate and operate the medical care coordination system. For example, the Home menu may provide navigation back to the default display page configured for the particular logged-in user at the console of the medical care management system. The Back button and Forward button of the menu bar 202 may provide back and forth access to various display pages that the logged-in user has visited during a period of time.

The GUI environment 200 includes a healthcare provider entity selection menu 222 and a patient selection menu 224. In some embodiments, the GUI 200 can further include trays 232 and 234 to provide pictorial and/or icon depictions for each of the healthcare provider entities and the patient entities, respectively. For example, a doctor can have his face picture and an initial of the first name and the full last name associated with the pictorial representation in the tray 232. A care team can have an icon of multiple people and a name assigned to the care team, e.g., Care Team A, associated with the icon to be enlisted in the tray 232. Similar for the patient entities, each patient can have a pictorial depiction associated with a name indication, e.g., the initial of a first name and a full last name enlisted in the tray. A clinician user 102 of FIG. 1 can utilize an input device, for example, a mouse, to select a particular healthcare provider entity from the selection menu 222, and to select a particular patient entity from the selection menu 224. As shown in FIG. 2A, the clinician selects healthcare provider entity as Dr. Batista, and the patient entity as patient Franzen, indicating the clinical timeline 300 to display the information regarding a one to one healthcare relationship between Dr. Batista and patient Franzen.

The detail panel 206 displays additional details about a clinical event or a composite clinical data item that is currently selected in the clinical timeline 300. As shown in FIG. 2A, the currently selected data item is an approval of a treatment plan, shown in the clinical timeline 300 in highlight. The details of the selected data item are illustrated in the detail panel 206. The additional details of the selected treatment plan approval includes an image, information regarding dosage applied to date during the course of the treatment, and the relevant planning parameters applied to the treatment plan approved.

FIG. 2B illustrates another exemplary GUI environment 250 for managing patient care and treatment, including a clinical timeline 400 for treatment viewing, planning and coordination. The GUI 250 also represents a console of a medical care coordination system, which is displayed to a clinician upon that particular clinician user's login (e.g., Rosie R.N.). The GUI 250 includes a plurality of tabs 254, a menu bar 252 configured for each of the tabs 254, and a clinical timeline 400. The clinical timeline 400 is shown to include a communication panel 256 to the right hand side.

The plurality of tabs 254 are located at the top of the GUI 250 and provide the users access to various applications of the medical care management system. For example, the Home tab may provide navigation to the default home page configured for the particular logged-in user at the console of the medical care management system. Under the Home tab, the menu bar 252 further provides application specific menu options to configure, navigate and operate the particular application of the medical care management system. For example, the View Button may provide short-cut access to a calendar view, patients' lab results, patients' charts, etc. The My Pinned Button may provide a filtered view of the clinical information that has been selected by the logged-in user as pinned items. The pinned items can be one or more to-do tasks such as to review a certain lab results bearing abnormal data, or to respond to a patient's complaint of symptoms in a diary entry after a course of a treatment.

The GUI environment 250 includes a healthcare provider entity selection menu 262-1 and 262-2, as well as a patient selection menu 264. In some embodiments, the drop-down selection menu 264 provides options for selecting a single patient, all the patients, or a group of patients according to different pre-configured criteria. For example, a group of the last 8 patients, next 8 patients, patients with new unread PRO records, patient with appointments this week, patients high risks, etc. Correspondingly, for the drop-down menu 264 enabling batch selection of patients, GUI 250 includes a tray 274 to provide pictorial and icon depictions for each of the patient entities selected by use of the menu 264. For example, each patient can have a pictorial depiction associated with a name indication, e.g., a full first name and a full last name listed in the tray 274. A clinician user 102 of FIG. 1 can also utilize an input device, for example, a mouse, to select a particular patient entity either from the tray 274. Upon the clinician's selection, the pictorial depiction of the selected patient entity is indicated, e.g., highlighted, both in the tray 274 and on the face of the selection menu 264. The clinician indicates an individual healthcare provider entity from the selection menu 262-1. Alternatively, the clinician can indicate a group of healthcare providers as a healthcare provider entity. In other words, the clinician can choose to view all the clinical data associated with a healthcare relationship with a single patient either from the perspective of a particular whole team working to treat the patient or a particular single clinician. In some embodiments, the GUI 250 allows the clinician to define the team members of a particular care team, as well as introduce or delete care teams associated with the healthcare environment. As shown in FIG. 2B, the clinician indicates the healthcare provider entity as Rosie, the logged-in user, and the patient entity as patient Taylor, for the clinical timeline 400 to display the clinical information on a many to one relationship.

The communication panel 256 displays various messages communicated between the indicated healthcare provider entity and the indicated patient entity. Such messages can be of any type of communication between the indicated parties, e.g., SMS or MMS or APP messages, telephone calls (including missed calls), social networking content posts, notifications and/or status updates, microblog (e.g., Twitter®) contents, as well as emails. Note however that these are non-limiting examples of communication data, and the technology described herein can aggregate and integrate such information from any source, including from sources not yet known. The communication panel 256 includes a plurality of message boxes 260, each of which includes various details regarding a particular message. Such details can be, but not limited to, the sender information, the recipient information, the subject of the message, the importance level of the message, and the content of the message. Further, each of the message boxes 280 also includes a time associated therewith, e.g., a sent time, a post time or a receive time. The time associated with the message box 280 correlates to the timeline via a link 282 to a corresponding time indicator of the timeline. In addition the content in the message can be clickable which points to a specific location in the timeline related to the content reference and not a specific time. Each of the message boxes 280 can further include an action item 284 to enable the user to, for example, execute a certain action in the computation system by use of an input device, e.g., a mouse, to select the item for actions. For example, the user can mouse click on a Reply button to respond to the message presented in the message box 280 within the context of the timeline 400.

Having described the GUI environments with respect to FIGS. 2A-2B, it is understood that the specific GUI environments of FIGS. 2A-2B are only two of many exemplary environments in which an exemplary clinical timeline 300 or 400 may operate. The scope of the timeline 300 or 400 is not intended to be limited to any particular GUI environment.

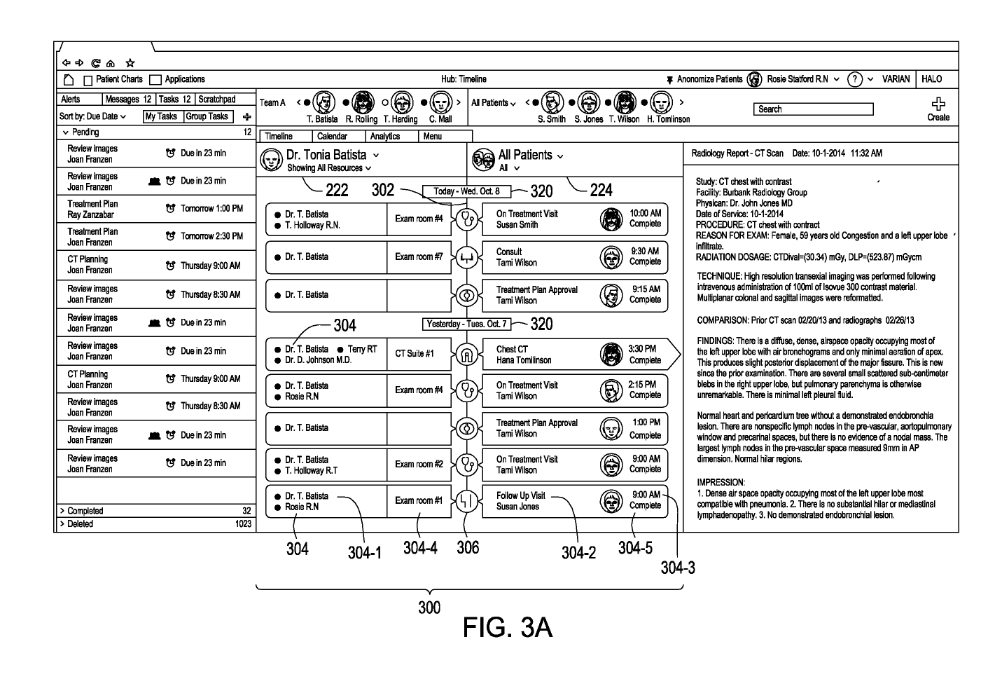

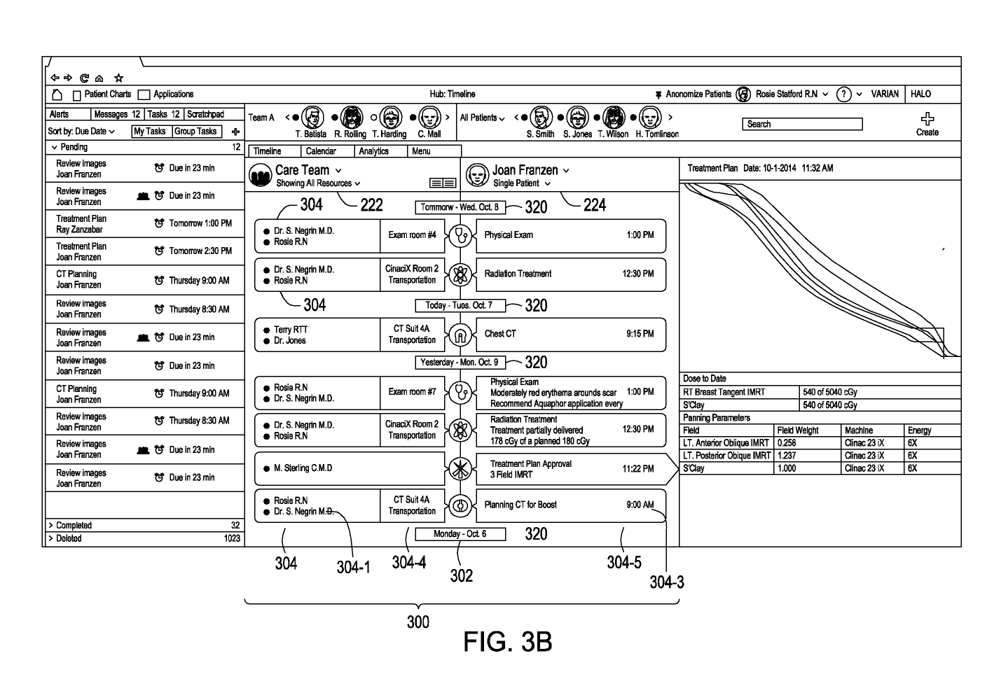

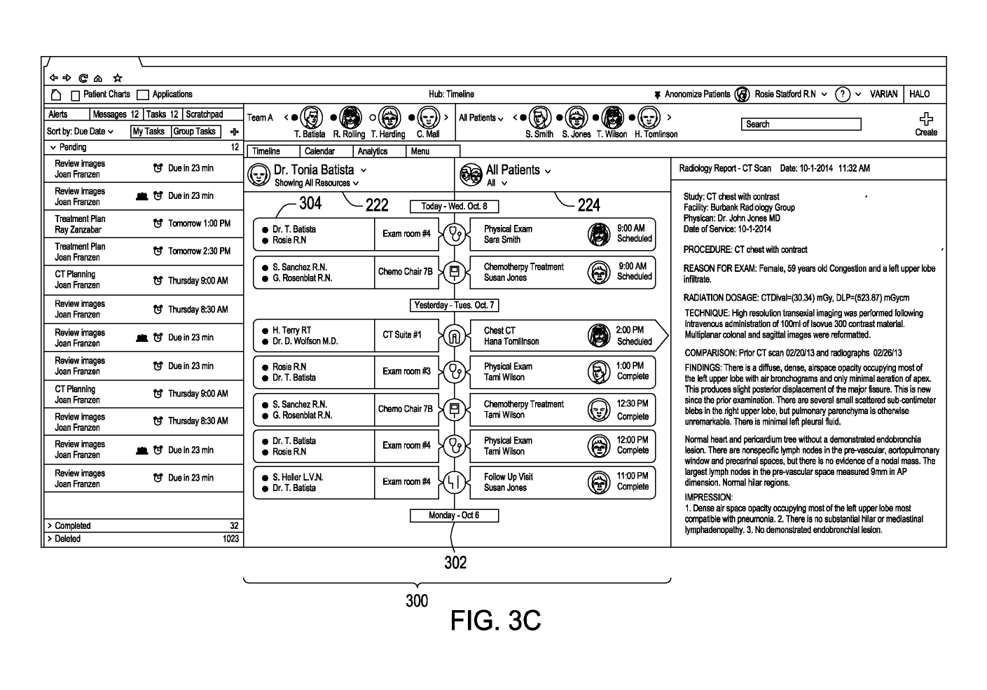

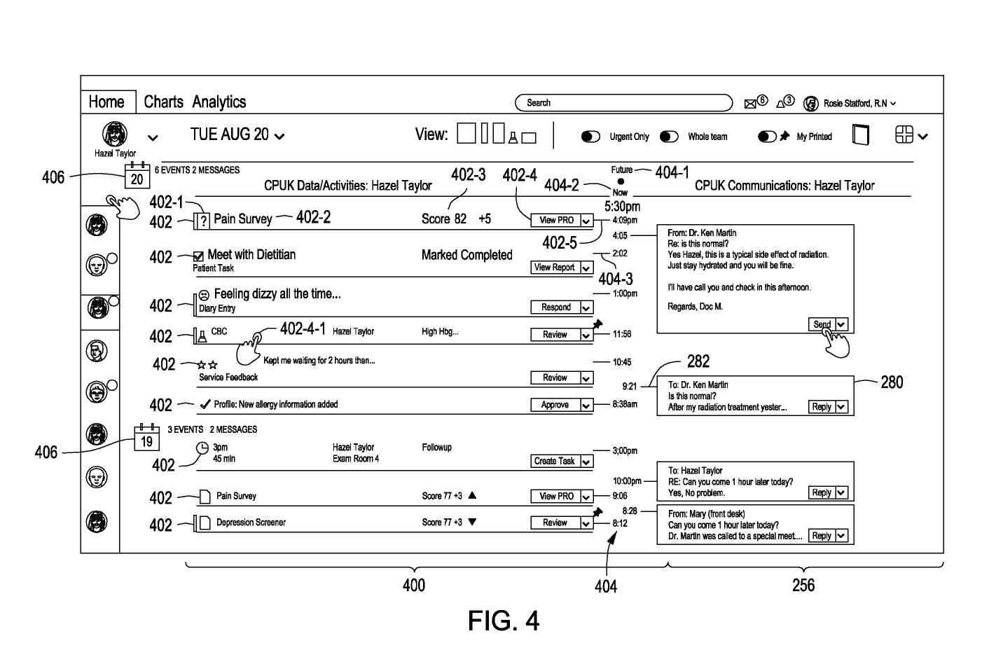

With reference now to FIGS. 3A-3C and 4, additional aspects of the clinical timeline 300 and 400 are shown in accordance with embodiments of the present disclosure.

Referring to FIG. 3A, the timeline 300 is shown to illustrate a one to many healthcare relationship in accordance with embodiments of the present disclosure. The clinical timeline 300 provides a visualization of all the clinical events and data pertaining to the one to many healthcare relationship indicated by the user 102 of FIG. 1 via the selection of a healthcare provider entity and a selection of a patient entity. As shown in FIG. 3A, the plurality of data items are filtered to include only the events and data relating to the healthcare relationship between the indicated provider entity, e.g., Dr. Batista and the indicated patient entity, all patients under the care of Dr. Batista. The filtered plurality of data items 304 are ordered and positioned based on the times associated therewith in a descending chronological order encompassing the time periods from the future to present to past. The chronological order is represented in the form of a vertical axis 302 running in the middle of the clinical timeline 300. Each of the data items 304 includes the healthcare provider entity information 304-1 to the left hand side, aligned underneath the selection menu 222. Each of the data items 304 includes the information of the indicated patient entity 304-2 to the right hand side, aligned underneath the selection menu 224. Each of the data items 304 includes an indicator 306 in the middle of the data item, intersecting with the axis 302 of the clinical timeline 300 at the indicator 306. Indicators 306 can be represented in a variety of forms such as, for example, icons, color-coded icons, etc. These represent the type of information. Each of the data items 304 further includes a time 304-3 associated therewith, displayed towards the right hand side of the data item 304 in the timeline 300. Each of the data items 304 also includes additional information pertaining to the clinical event such as venue information 304-4 and status information 304-5.

The clinical timeline 300 can further include some structural displays that are optional. For example, due a size limit of a displaying screen for the timeline 300, without rendering the entire collection of the running events and data associated with the timeline, the timeline can have visual markers/enhancers such as day separator 320. As shown in FIG. 3A, a separator 320 is displayed at the top of the running axis 302, indicating the information of today and the calendar date of today, as there are not any clinical events or data associated with this particular healthcare relationship in the future. Another separator 320 is displayed at the border between the plurality of data items associated with the time periods of today and the plurality of data items associated with the time periods of yesterday.

The clinical timeline 300 can include a slider to facilitate user navigation along the timeline to view clinical events and data such that to accommodate various screen sizes of the user-end devices at which the user is accessing the timeline. The timeline includes a scroll line associated with the slider to indicate a subset of clinical events and data currently viewable in a view area of the timeline. The scroll line and associated detail panel are scalable based on available display real estate.

Referring to FIG. 3B, the on-screen timeline 300 is shown to illustrate a many to one healthcare relationship in accordance with embodiments of the present disclosure. The visualization provided by the clinical timeline 300 represents all the clinical events and data pertaining to the many to one healthcare relationship indicated by the user 102 of FIG. 1 via the selection of a healthcare provider entity and a selection of a patient entity. As shown in FIG. 3B, the plurality of data items are filtered to include only the information relating to the healthcare relationship between the indicated provider entity, care team 2A, and the indicated patient entity, an individual patient Franzen. Like the data items of FIG. 3A, the filtered plurality of data items 304 are ordered and positioned based on the times associated therewith in a descending chronological order along the vertical axis 302 running in the middle of the clinical timeline 300.

The healthcare relationship indicated for the timeline 300 of FIG. 3B includes data items associated with times in the future. Therefore, a separator 320 is shown at the top of the running axis 302 indicating tomorrow and a calendar date of tomorrow. Accordingly, the plurality of data items associated with different other days are grouped with the corresponding day separators 320 in between.

Referring to FIG. 3C, the on-screen timeline 300 of FIG. 2A is shown to illustrate a one to many healthcare relationship in accordance with embodiments of the present disclosure. The visualization provided by the clinical timeline 300 represents all the clinical events and data pertaining to the healthcare relationship indicated by the user 102 of FIG. 1 via the selection of a healthcare provider entity and a selection of a patient entity. As shown in FIG. 3C, the plurality of data items are filtered to include only the information relating to the healthcare relationship between the indicated provider entity, Dr. Batista, and the indicated patient entity, all the patients under this doctors care. Like the data items of FIGS. 3A and 3B, the filtered plurality of data items 304 are ordered and positioned based on the times associated therewith in a descending chronological order along the vertical axis 302 running in the middle of the clinical timeline 300.

According to some embodiments, the information displayed by an on-screen timeline (e.g., on-screen timeline 300) is automatically adjusted based on the healthcare provider that is currently using the system and/or the current activity of the healthcare provider. For example, a first set of information will be displayed when a nurse is using the system, and a second set of information will be displayed when a surgeon is using the system. Although the first set of information and the second set of information may include some information that is the same, in general, the first set of information is specifically tailored to the nurse, and the second set of information is specifically tailored to the surgeon. Furthermore, while the surgeon is preparing to perform a surgical procedure, preliminary information maybe displayed. When the surgeon begins performing various stages of the surgical procedure, active information is displayed and updated as necessary (e.g., when a new stage of the procedure is reached or new information becomes available).

Referring to FIG. 4, the exemplary on-screen clinical timeline 400 of FIG. 2B is shown in accordance with an embodiment with the present disclosure. The clinical timeline 400 provides a visualization of the clinical events and data that associate the healthcare relationship between the clinician indicated patient, e.g., Taylor and the healthcare provider entity Rosie, R.N. The feed view will logically be a variation of the many-to-one view though it can be adjusted to reduce to a one to one view via the “Whole team” slider control <needs to be numbered in the drawing>. Since it is the history of a single patient, it can show every encounter. All team members see the identical screen in the many to one view condition. The clinical timeline 400 includes a vertical axis area 404 positioned about the middle of the timeline, the axis area 404 representing the running time encompassing future, present and past information. The axis area 404 includes a Future indicator 404-1 at the top thereof, a Now indicator with a current time in a prominent display, and a plurality of time indicators 404-3 displaying various times in the past. Unlike the Now indicator 404-2 and the Future indicator 404-1, which does not need to associate with any data items of the timeline 400, each of the past time indicators 404-3 is associated with the plurality of timeline data items, including the message boxes 280 in the communication panel 256. In some embodiments, the Future indicator 404-1 can be implemented as an actionable widget, allowing the user to select the indicator to expand the prior collapsed view of the clinical events and data associated with a time in the future. Likewise, the Future indicator 404-1 also allows the user to compress (hide) the prior expanded view of the future clinical events and data in the timeline, displaying only the Future indicator 404-1.

The clinical timeline 400 can include additional day separators 406 to organize the chronologically ordered clinical events and data by calendar days. In some embodiments, the timeline separator 406 includes a calendar date indicator. In some other embodiments, the timeline separator 406 further includes a quick-glance summary of the clinical events and data along that particular calendar date. For example, for a present day on August 20, until a present time 5:30 pm, there have been 6 events and 2 messages. Here, the events include both the clinical tasks and the clinical data available.

According to some embodiments, a conflict between two or more events of the timeline may be detected. When multiple events for a user are scheduled at the same time, or multiple events are close in temporal proximity but at locations that are far apart, a conflict is detected, and the GUI notifies the user or the parties to the scheduled conflict. Furthermore, the GUI may suggest an alternate time or location to avoid the conflict. For example, if a command, order or clinical decision is entered, chronological events may be analyzed to detect an event conflict. When a doctor prescribes blood work, but a nurse has already indicated that the patient's vein has collapsed and blood work may be difficult, the interface notified the individual prescribing the blood work that a conflict has been detected. In another example, a therapist schedules radiation therapy, but a doctor has previously indicated that no more radiation therapy can occur until the patient has been examined. In this case, the GUI notifies the therapist to prevent potential harm to the patient. In another example, a patient has been diagnosed using MRI. Although Mill images can be used for treatment planning, the planning software at the hospital may be limited to using CT scan data as input data for planning. In this case, the system detects the potential conflict and notifies the physicist or dosimetrist that CT images are needed.

The clinical timeline 400 includes a plurality of data items 402 positioned horizontally and intersecting with the vertical axis area 404. Each of the data items 402 of the clinical timeline correlates via a link 402-5 to the corresponding time 404-3 along the vertical axis area 404. The plurality of data items 402 are ordered according to the times 404-3 associated therewith in a chronological order. Each of the data items provides visualized information corresponding to a clinical event or data. In some embodiments, the data item 402 includes an icon 402-1 representing a category of the clinical data, such as, for example, pain survey, patient experience survey, patient diary entry, lab results, profile change, clinician appointments as well as patient tasks. Each of the data items 402 includes a brief textual description 402-2 of the corresponding icons. For certain data items 402, quick-glance descriptions 402-3 to highlight the most salient or urgent information or status thereof are further included. For example, the quick-glance description 402-3 can present an abnormal CBC result with a red colored text “High Hbg” to alert the clinician viewing the timeline. The quick-glance description 402-3 can also flag an upward or downward change in a score of a patient reported outcome measurement such as the pain level or the depression level, etc. Other urgent information may be displayed in the GUI as a warning or notification based on past clinical events. For example, during treatment, a patient may experience a severe allergic reaction to a certain drug or form of treatment. At a later time, if a healthcare provider enters a prescription for the same drug or treatment, or a drug or treatment that is substantially similar, the GUI will display a warning that the new even (entering the prescription) may be dangerous for the patient. According to some embodiments, the user must manually reject or override the warning before the new event will be entered.

According to some embodiments, clinical data and relationship information may be displayed in a timeline based on a correlation to similar events. For example, when a user has been treated by Oncologist A in the past, the relationship between the user and Oncologist A is stored in the system. At a later time, the user may begin treatment with another doctor, Oncologist B. The system identifies that oncological treatment is a similar event that has occurred in the past. In this case, the GUI will display clinical data and relationship data based on the relationship between Oncologist A and the user being the same as the relationship between Oncologist B and the user.

In addition to viewing the clinical information pertaining to the selected healthcare relationship between the indicted healthcare provider entity and the patient entity, the clinical timeline 400 allows the clinician to interact, modify and create new events to take place for the selected healthcare relationship via actionable elements 402-4 associated with corresponding data items 402. The actionable elements 402-4 are configured to allow the clinician to execute suitable actions upon the clinical information represented in the data item 402. For example, the clinician can select the actionable element by use of an input device, e.g., a mouse, to view a particular patient reported outcome measurement (PROM), view a dietitian's note regarding the appointment with the patient, review a CBC report, review details of patient reported experience measurement (PREM), approve changes to the patient's profile on record, or to create tasks of appointments, treatments, ordering lab tests, CT tests, etc.

The actionable elements 402-4 also allow the clinician to execute actions that are not pre-configured for the corresponding categories of the clinical events and data as described above. For example, for composite clinical data such as CBC results, the data item 402 displays a clicking icon 402-4-1 when the clinician hovers over the data item 402 a cursor appears shown as 402-4-1. Upon the display of the cursor, the clinician can execute the expanding action inherent to the clinical data to view the additional details of the report in the context of the timeline.

In some embodiments, the indicated healthcare provider entity is the logged-in clinician, and the clinician enters new tasks for him or herself into the clinical timeline to manage his or her own activities in the treatment of one or more patients. In some other embodiments, the logged-in clinician can select a healthcare provider entity other than himself or herself. For example, a head nurse logged into the timeline 400 can nevertheless choose from the selection drop down menu 222 to choose someone else if they had permission to view that person's data. For example, by changing the selection of the single patient Taylor to all the patients, the head nurse user can view the overall activities regarding the assisting doctor's schedule before making new appointments for the patient Taylor with the assisting doctor.

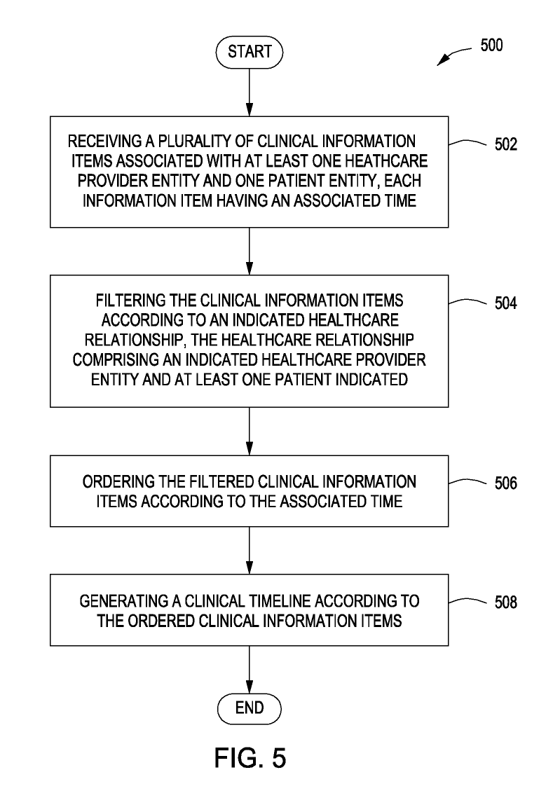

FIG. 5 is a flow chart of an exemplary computer implemented method of generating a clinical timeline in accordance with embodiments of the present disclosure. The method 500 starts in step 502, in which a plurality of clinical information items from a plurality of information sources are received by the timeline engine 104. Each of the clinical information items is associated with at least one healthcare provider entity and one patient entity. Each of the clinical information items also includes an associated time.

In step 504, the plurality of clinical information data are filtered based on a healthcare relationship. The healthcare relationship includes a healthcare provider entity indicated by the user 102a and a patient entity indicated by the user 102b. In step 506, the filtered plurality of clinical information items are ordered based on the associated time in a chronological order. In step 508, a clinical timeline is generated based on the ordered plurality of clinical information items.

Aspects of this disclosure are described herein with reference to flowchart illustrations or block diagrams, in which each block or any combination of blocks can be implemented by computer program instructions. The instructions may be provided to a processor of a general purpose computer, special purpose computer, or other programmable data processing system to effectuate a machine or article of manufacture, and when executed by the processor the instructions create means for implementing the functions, acts or events specified in each block or combination of blocks in the diagrams.

In this regard, each block in the flowchart or block diagrams may correspond to a module, segment, or portion of code that including one or more executable instructions for implementing the specified logical function(s). It should also be noted that, in some alternative implementations, the functionality associated with any block may occur out of the order noted in the figures. For example, two blocks shown in succession may, in fact, be executed substantially concurrent, or blocks may sometimes be executed in reverse order.

A person of ordinary skill in the art will appreciate that aspects of this disclosure may be embodied as a device, system, method or computer program product. Accordingly, aspects of this disclosure, generally referred to herein as circuits, modules, components or systems, may be embodied in hardware, in software (including firmware, resident software, micro-code, etc.), or in any combination of software and hardware, including computer program products embodied in a computer-readable medium having computer-readable program code embodied thereon.

In this respect, any combination of one or more computer readable media may be utilized, including, but not limited to, an electronic, magnetic, optical, electromagnetic, infrared, or semiconductor system, apparatus, or device, or any suitable combination of these. In the context of this disclosure, a computer readable storage medium may include any tangible medium that is capable of containing or storing program instructions for use by or in connection with a data processing system, apparatus, or device.

Computer program code for carrying out operations regarding aspects of this disclosure may be written in any combination of one or more programming languages. The program code may execute entirely on an individual personal computer, as a stand-alone software package, partly on a client computer and partly on a remote server computer, entirely on a remote server or computer, or on a cluster of distributed computer nodes.

It will be understood that various modifications may be made. For example, useful results still could be achieved if steps of the disclosed techniques were performed in a different order, and/or if components in the disclosed systems were combined in a different manner and/or replaced or supplemented by other components. Accordingly, other implementations are within the scope of the following claims.

What is claimed is:

1. A method of generating a user interface including a clinical timeline, the method comprising:
receiving a plurality of clinical information items from a plurality of clinical sources, associated with at least one relationship between a healthcare provider entity and a patient entity, each clinical information item having an associated time;
filtering the plurality of clinical information items according to a relationship to generate filtered clinical information item views, wherein the relationship comprises an indicated one or more healthcare provider entities and at least one indicated patient;
ordering the filtered clinical information items according to the associated time to generate ordered clinical information items; and
generating a clinical timeline according to the ordered clinical information items that can show both the past and the future in a single view.

2. The method of claim 1, further comprising presenting the generated clinical timeline to a clinician.

3. The method of claim 1, wherein the indicated healthcare provider entity comprises at least one clinician.

4. The method of claim 2, wherein the clinical timeline comprises selection elements operable to enable the clinician to select the indicated healthcare provider entity and the indicated patient to filter the clinical information items of the clinical timeline.

5. The method of claim 2, further comprising allowing the clinician to modify the clinical information items of the clinical timeline.

6. The method of claim 2, wherein the clinical timeline allows the clinician to select a clinical information item therefrom for detail viewing in a detail panel.

7. The method of claim 2, wherein the plurality of clinical information items comprises messages communicated between the indicated healthcare provider entity and the indicated patient, and wherein the messages communicated are presented in a communication panel.

8. A system for generating a clinical timeline, the system comprising:
a memory that stores machine-readable instructions; and
a processor communicatively coupled to the memory, the processor operable to execute the instructions to implement a method of generating a clinical timeline user interface, the method comprising:
receiving a plurality of clinical information items associated with at least one relationship between a healthcare provider entity and a patient entity, each clinical information item having an associated time;
filtering the plurality of clinical information items according to a relationship to generate filtered clinical information items, wherein the relationship comprises an indicated healthcare provider entity and at least one indicated patient;
ordering the filtered clinical information items according to the associated time to generate ordered clinical information items; and
generating a clinical timeline according to the ordered clinical information items.

9. The system of claim 8, wherein the process further comprises presenting the generated clinical timeline to a clinician.

10. The system of claim 8, wherein the indicated healthcare provider entity comprises at least one clinician.

11. The system of claim 9, wherein the clinical timeline comprises selection elements operable to enable the clinician to select the indicated healthcare provider entity and the indicated patient to filter the clinical information items of the clinical timeline.

12. The system of claim 9, wherein the method further comprises allowing the clinician to modify the clinical information items of the clinical timeline.

13. The system of claim 9, wherein the clinical timeline allows the clinician to select a clinical information item therefrom for detail viewing in a detail pane.

14. The system of claim 9, wherein the plurality of clinical information items comprises messages communicated between the indicated healthcare provider entity and the indicated patient, and wherein the messages communicated are presented in a communication panel.

15. A non-transitory computer readable storage medium having embedded therein program instructions, when executed by one or more processors of a device, causes the device to execute a method for generating a clinical timeline, the method comprising:
receiving a plurality of clinical information items associated with at least one relationship between a healthcare provider entity and a patient entity, each clinical information item having an associated time;
filtering the clinical information items according to a relationship, wherein the relationship comprises an indicated healthcare provider entity and at least one indicated patient;
ordering the filtered clinical information items according to the associated time; and
generating a clinical timeline according to the ordered clinical information items.

16. The non-transitory computer readable storage medium of claim 15, wherein the method further comprises presenting the generated clinical timeline to a clinician.

17. The non-transitory computer readable storage medium of claim 15, wherein the indicated healthcare provider entity comprises at least one clinician.

18. The non-transitory computer readable storage medium of claim 15, wherein the clinical timeline enables the clinician to select the indicated healthcare provider entity and the indicated patient to filter the clinical information items of the clinical timeline.
